(19) United States
(12) Patent Application Publication
(10) Pub. No.: US 2012/0169631 A1
(43) Pub. Date: Jul. 5, 2012

(54) TOUCH SCREEN PANEL AND DRIVING METHOD THEREOF

(76) Inventor: Soon-Sung Ahn, Yongin-city (KR)

(21) Appl. No.: 13/237,885

(22) Filed: Sep. 20, 2011

(30) Foreign Application Priority Data
Dec. 29, 2010 (KR) 10-2010-0137988

(51) Int. Cl. G06F 3/041

(52) U.S. Cl. 345/173

(57) ABSTRACT

A touch screen panel according to an embodiment of the present invention includes: a substrate; a plurality of driving electrodes including first driving patterns and second driving patterns and arranged on the substrate along a first direction; and a plurality of sensing electrodes including first sensing patterns and second sensing patterns and arranged on the substrate along a second direction crossing the first direction, wherein first sensing cells are formed of the first driving patterns and the first sensing patterns and second sensing cells are formed of the second driving patterns and the second sensing patterns.

### CROSS-REFERENCE TO RELATED APPLICATION

This application claims priority to and the benefit of Korean Patent Application No. 10-2010-0137988, filed on Dec. 29, 2010 in the Korean Intellectual Property Office, the entire content of which is incorporated herein by reference.

### BACKGROUND

1. Field

Aspects of embodiments of the present invention relate to a touch screen panel and a driving method thereof.

2. Description of the Related Art

A touch screen panel is an input device that allows a person to select instructions displayed on a screen such as an image display device, etc., using the person's hand or an object to input instructions of a user.

To this end, a touch screen panel may be provided on a front face of the image display device to convert positions directly touched by a person's hand or an object into electrical signals. Therefore, the instructions selected at the touched positions are received as input signals.

As the touch screen panel can replace a separate input device that is operated by being connected with the image display device such as a keyboard or a mouse, use of the touch screen panel is gradually being expanded.

Various types of touch screen panels have been implemented, including a resistive type, a light sensing type, a capacitive type, and so on. Among those, the capacitive touch screen panel senses touched positions by allowing a conductive sensing pattern to sense a change in capacitance generated by other sensing patterns around the conductive sensing pattern, a ground electrode, etc., when a person's finger or object touches the touch screen panel.

However, when a person's finger touches the capacitive touch screen panel, the person's body (i.e., a human body) serves as a noise source, such that noises from the human body may be applied to the sensing pattern, thereby degrading the sensing accuracy of the touched positions.

To address the problem, as shown in FIG. 1(a), when detection signals output from directly adjacent sensing patterns (sensors) 1 and 2 are differentially amplified (DA), the noises are removed, but the touched signals of the object (finger) are not shown and as a result, it is difficult or impossible to determine the touched positions. As shown in FIG. 1(b), when detection signals output from a sensing pattern 10 to which a finger is touched and a sensing pattern 3 to which a finger is not touched are differentially amplified (DA), since the distance between the sensing pattern 3 and the sensing pattern 10 is greater than the size of a finger, the noises applied from the human body are not removed.

### SUMMARY

Therefore, aspects of embodiments of the present invention provide a touch screen panel capable of more accurately sensing touched positions by removing noises applied from a human body, and a driving method thereof.

A touch screen panel according to an embodiment of the present invention includes: a substrate; a plurality of driving electrodes including first driving patterns and second driving patterns and arranged on the substrate along a first direction; and a plurality of sensing electrodes including first sensing patterns and second sensing patterns and arranged on the substrate along a second direction crossing the first direction, wherein first sensing cells are formed of the first driving patterns and the first sensing patterns and second sensing cells are formed of the second driving patterns and the second sensing patterns.

Each of the first driving patterns may include: a first reference pattern extending in the second direction; and a plurality of first protruding patterns extending to one side from the first reference pattern, and each of the first sensing patterns may include: a third reference pattern extending in the first direction; and a plurality of third protruding patterns extending from the third reference pattern and alternately arranged with the first protruding patterns to form the first sensing cells.

Each of the second driving patterns may include: a second reference pattern extending in the second direction; and a plurality of second protruding patterns extending to one side from the second reference pattern, and each of the second sensing patterns may include: a fourth reference pattern extending in the first direction; and a plurality of fourth protruding patterns extending from the fourth reference pattern and alternately arranged with the second protruding patterns to form the second sensing cells.

The touch screen panel may further include a driving signal supplying unit for sequentially supplying driving signals to the plurality of driving electrodes.

The driving signal supply unit may be configured to supply a first driving signal of the driving signals to the first driving patterns during a first driving period, to supply a second driving signal of the driving signals to the first driving patterns during a second driving period, to supply a third driving signal of the driving signals to the second driving patterns during the first driving period, and to supply a fourth driving signal of the driving signals to the second driving patterns during the second driving period.

The third driving signal may be concurrently supplied with the first driving signal.

The touch screen panel may further include a plurality of differential amplifiers having input terminals, each of the differential amplifiers being coupled to the first sensing pattern and the second sensing pattern in a corresponding one of the sensing electrodes.

The touch screen panel may further include a touch detector coupled to an output terminal of each of the differential amplifiers.

A method of driving a touch screen panel according to an embodiment of the present invention includes: (a) sequentially supplying a first driving signal and a third driving signal to each driving electrode of a plurality of driving electrodes during a first driving period, wherein the first driving signal and the third driving signal are concurrently supplied to a first driving pattern and a second driving pattern of each of the driving electrodes; (b) sequentially supplying a second driving signal and a fourth driving signal to each driving electrode of the plurality of driving electrodes during a second driving period, wherein the second driving signal is supplied to the first driving pattern of each of the driving electrodes and the fourth driving signal is supplied to the second driving pattern of each of the driving electrodes; (c) differentially amplifying a first detection signal and a second detection signal output from a first sensing pattern and a second sensing pattern of each sensing electrode of a plurality of sensing electrodes, respectively, to remove noises while generating differentially amplified detection signals; and (d) recognizing touch coordinates by using the differentially amplified detection signals.

The first driving pattern and the first sensing pattern may form a first sensing cell and the second driving pattern and the second sensing pattern may form a second sensing cell.

The first driving pattern may include: a first reference pattern extending in a second direction; and a plurality of first protruding patterns extending to one side from the first reference pattern, and the first sensing pattern may include: a third reference pattern extending in a first direction; and a plurality of third protruding patterns extending from the third reference pattern and alternately arranged with the first protruding patterns to form the first sensing cell.

The second driving pattern may include: a second reference pattern extending in the second direction; and a plurality of second protruding patterns extending to one side from the second reference pattern, and the second sensing pattern may include: a fourth reference pattern extending in the first direction; and a plurality of fourth protruding patterns extending from the fourth reference pattern and alternately arranged with the second protruding patterns to form the second sensing cell.

As set forth above, an exemplary embodiment of the present invention provides a touch screen panel capable of more accurately sensing touched positions by removing noises applied from a human body, and a driving method thereof.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a reference diagram for describing a problem according to related art;

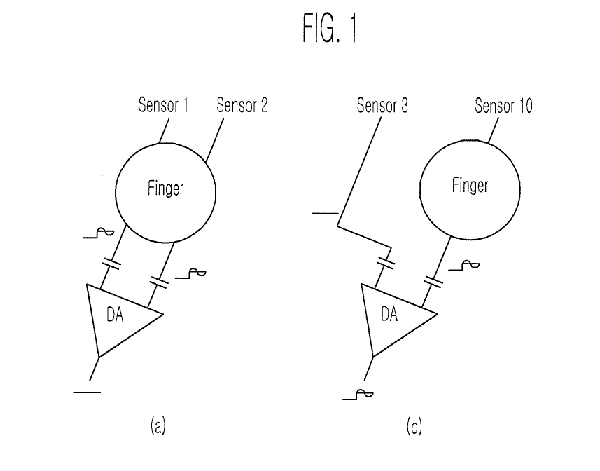

FIG. 2 is a diagram showing a touch screen panel according to an exemplary embodiment of the present invention;

FIGS. 3A and 3B are diagrams showing a driving electrode and a sensing electrode, respectively, according to an exemplary embodiment of the present invention;

FIG. 4 is a diagram showing a coupling state of the driving electrode and the sensing electrode shown in FIGS. 3A and 3B according to an exemplary embodiment of the present invention;

FIG. 5 is an enlarged view and a cross-sectional view of an overlapping region of the driving electrodes and the sensing electrodes shown in FIG. 4;

FIG. 6 is a waveform diagram showing driving signals according to an exemplary embodiment of the present invention; and

FIGS. 7A to 7D are diagrams schematically showing a driving method of a touch screen panel according to an exemplary embodiment of the present invention.

### DETAILED DESCRIPTION

In the following detailed description, only certain exemplary embodiments of the present invention are shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Exemplary embodiments of the present invention will be described with reference to the accompanying drawings.

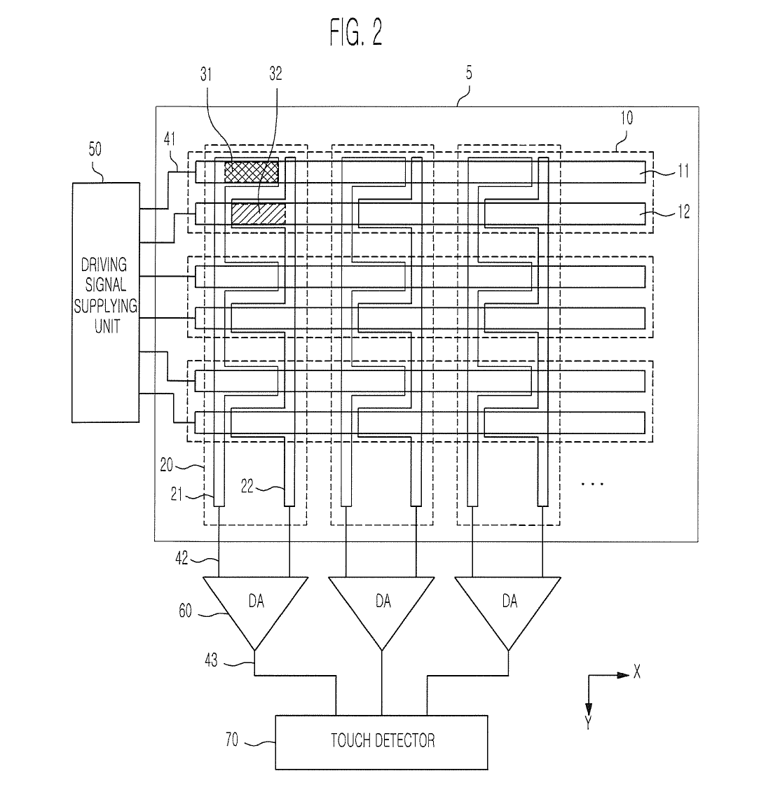

FIG. 2 is a diagram showing a touch screen panel according to an exemplary embodiment of the present invention.

The touch screen panel according to an exemplary embodiment of the present invention is configured to include a substrate 5, a plurality of driving electrodes 10, and a plurality of sensing electrodes 20. The plurality of driving electrodes 10 and the plurality of sensing electrodes 20 form first sensing cells 31 and second sensing cells 32.

The substrate 5 may be a transparent substrate having a plurality of driving electrodes 10 and sensing electrodes 20 disposed on an upper surface (e.g., the top portion) thereof. The transparent substrate may be made of, for example, a material having insulation, such as glass, plastic, silicon, or a synthetic resin. The transparent substrate may be made of a flexible film.

The plurality of driving electrodes 10 are arranged on the substrate 5 along a first direction (for example, Y-axis direction) and are configured to include first driving patterns 11 and second driving patterns 12.

The plurality of sensing electrodes 20 are arranged on the substrate 5 along a second direction (for example, X-axis direction) crossing (or intersecting with) the first direction and include (or are formed of) a first sensing pattern 21 and a second sensing pattern 22.

The driving electrodes 10 and the sensing electrodes 20 may be made of a transparent conductive material such as indium tin oxide (ITO). Further, FIG. 2 shows the case where the number of driving electrodes and sensing electrodes is reduced for the convenience of explanation, but the number thereof may be variously changed according to the size of the touch screen panel.

In particular, the first driving patterns 11 of each driving electrode 10 and the first sensing patterns 21 of each sensing electrode 20 form first sensing cells 31. The second driving patterns 12 of each driving electrode 10 and the second sensing patterns 22 of each sensing electrode 20 form second sensing cells 32.

Further, a touch screen panel according to an exemplary embodiment of the present invention may further include a driving signal supplying unit 50, a plurality of differential amplifiers 60, and a touch detector 70.

The driving signal supplying unit 50 is coupled (or connected) to the first driving patterns 11 and the second driving patterns 12 of each driving electrode 10 and sequentially supplies driving signals to each driving electrode 10, through driving lines 41.

The plurality of differential amplifiers 60 are provided so that the input terminals thereof are coupled (or connected) to each sensing electrode 20. Therefore, the number of differential amplifiers may be provided to be equal to the number of sensing electrodes 20.

The first sensing patterns 21 and the second sensing patterns 22 included in each sensing electrode 20 are each coupled (or connected) to the input terminals of the differential amplifiers 60 through input lines 42.

Therefore, detection signals output from each sensing pattern 21 and 22 are input to the input terminals of the corresponding differential amplifier 60. Accordingly, the two applied detection signals are differentially amplified, and the resulting signal is in turn output to the output terminal of the differential amplifier. The signal output to the output terminal of the differential amplifier 60 may be referred to as a differential signal.

The touch detector 70 is coupled (or connected) to the output terminal of each differential amplifier through an output line 43. Therefore, a change in capacitance according to touched positions of a user's finger, objects, etc., is determined by using the differential signals output (or applied) from each differential amplifier 60, which serves to determine whether the touch screen panel has been touched or not, and the touched positions.

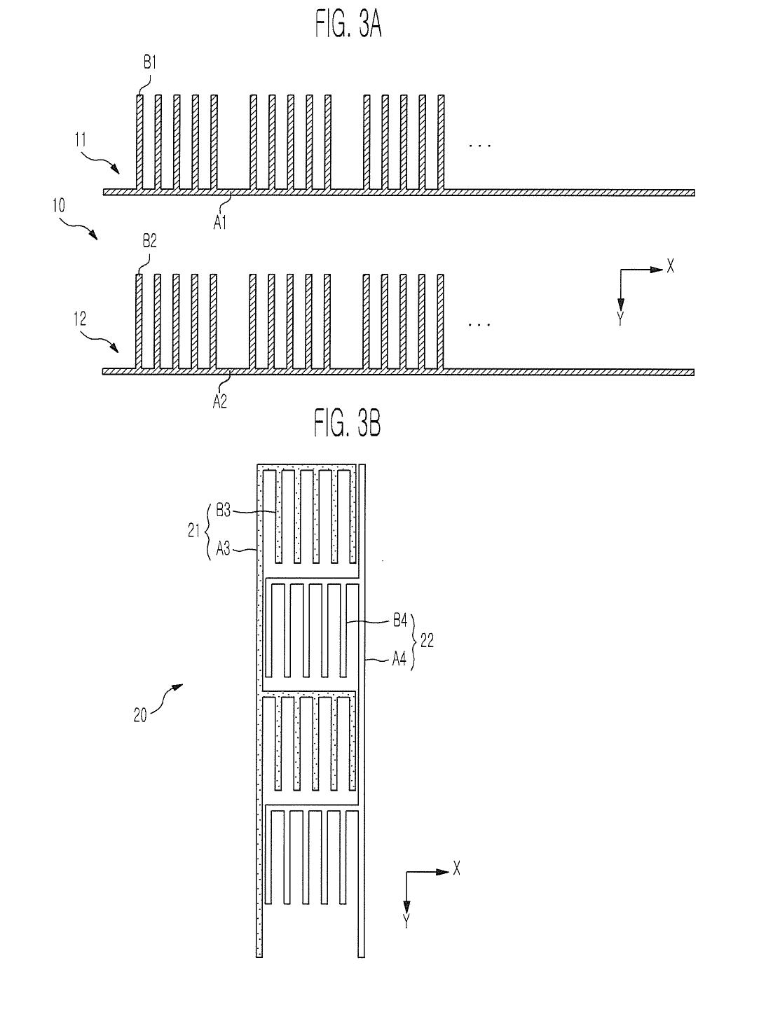

FIGS. 3A and 3B are diagrams showing a driving electrode and a sensing electrode, respectively, according to an exemplary embodiment of the present invention.

Referring to FIG. 3A, the first driving patterns 11 according to an exemplary embodiment of the present invention are configured to include first reference patterns A1 and first protruding patterns B1, and the second driving patterns 12 are configured to include second reference patterns A2 and second protruding patterns B2.

The first reference pattern A1 and the second reference pattern A2 are each formed in the second direction (for example, X-axis direction). The plurality of first protruding patterns B1 is extendedly formed to protrude from one side of the first reference patterns A1, and the plurality of second protruding patterns B2 is extendedly formed to protrude from one side of the second reference patterns A2. FIG. 3A shows the case where each of the protruding patterns B1 and B2 is formed to extend upwardly. However, each of the protruding patterns B1 and B2 may be formed to extend downwardly.

Referring to FIG. 3B, the first sensing pattern 21 according to an exemplary embodiment of the present invention is configured to include third reference patterns A3 and third protruding patterns B3, and the second sensing patterns 22 are configured to include fourth reference patterns A4 and fourth protruding patterns B4.

The third reference patterns A3 and the fourth reference patterns A4 are each formed in a first direction (for example, Y-axis direction) crossing (or intersecting with) the first reference patterns A1, and the plurality of third protruding patterns B3 is formed to extend to one side from the third reference patterns A3 and the plurality of fourth protruding patterns B4 is formed to extend to one side from the fourth reference patterns A4.

The third protruding patterns B3 are alternately arranged with the first protruding patterns B1 (e.g., arranged with a predetermined number of the first protruding patterns B1) to form the first sensing cells 31, and the third protruding patterns B3 may be bent to protrude in one direction as shown in FIG. 3B. Therefore, the third protruding patterns B3 are formed to be parallel with the third reference patterns A3.

Similarly, the fourth protruding patterns B4 are alternately arranged with the second protruding patterns B2 (e.g., arranged with a predetermined number of the second protruding patterns B2) to form the second sensing cells 32, and the fourth protruding patterns B4 may be bent to protrude in one direction as shown in FIG. 3B. Therefore, the fourth protruding patterns B4 are formed to be parallel with the fourth reference patterns A4.

However, instead of the third protruding pattern B3 and the fourth protruding pattern B4 being bent to protrude in one direction, the first protruding pattern B1 and the second protruding pattern B2 may be bent to protrude in one direction. In this case, the first protruding pattern B1 would be parallel with the first reference patterns A1 and the second protruding patterns B2 would be parallel with the second reference patterns A2.

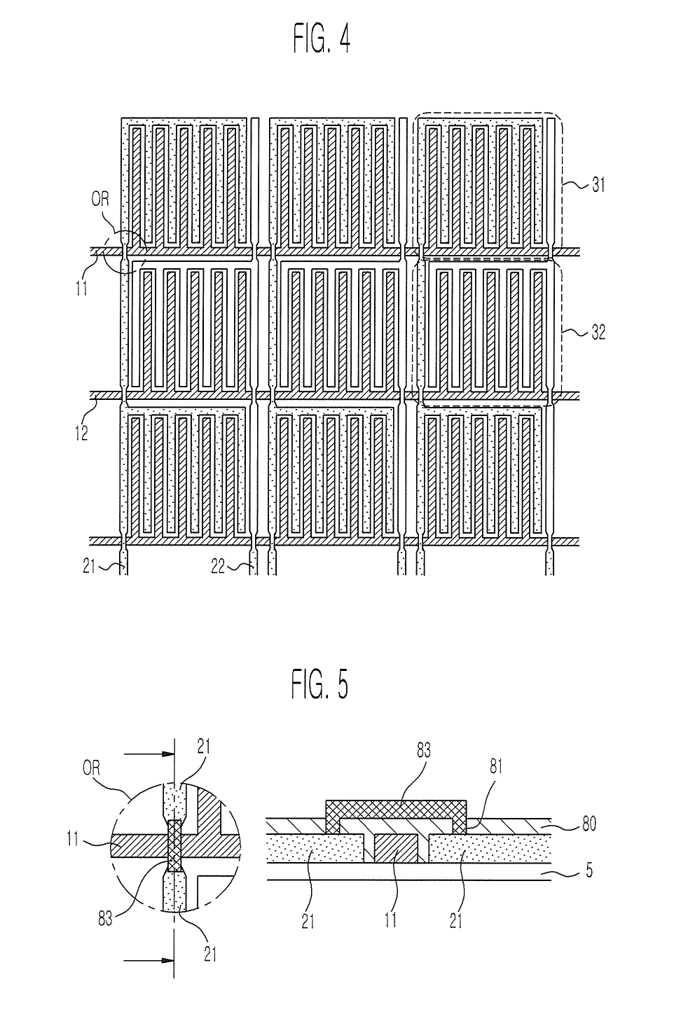

FIG. 4 is a diagram showing a coupling state of the driving electrodes and the sensing electrodes shown in FIGS. 3A and 3B according to an exemplary embodiment of the present invention.

Referring to FIG. 4, the first sensing cells 31 and the second sensing cells 32 are formed by coupling the driving electrode 10 with a plurality of the sensing electrodes 20 shown in FIGS. 3A and 3B, respectively.

The first sensing cells 31 are formed by the first protruding patterns B1 of the first driving patterns 11 and the third protruding patterns B3 of the first sensing patterns 21 that are alternately arranged with each other.

In addition, the second sensing cells 32 are formed by the second protruding patterns B2 of the second driving patterns 12 and the fourth protruding patterns B4 of the second sensing patterns 22 that are alternately arranged with each other.

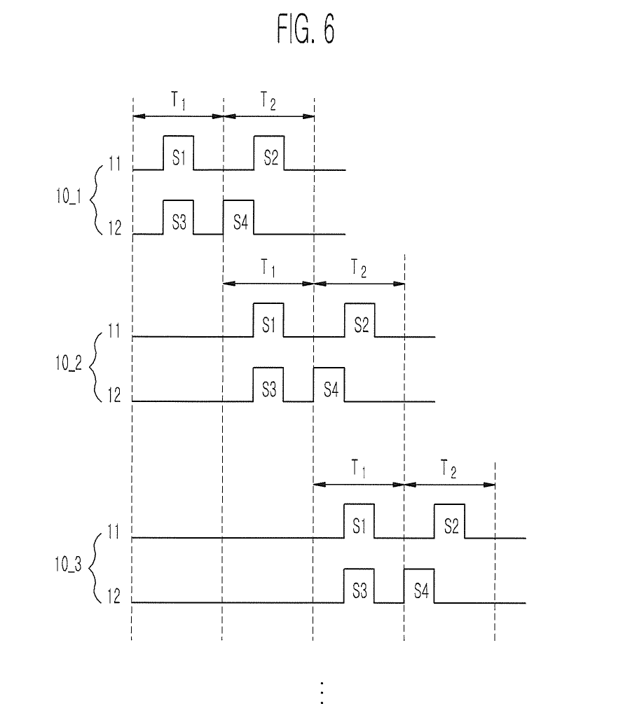

FIG. 5 is an enlarged view and a cross-sectional view of an overlapping region of the driving electrodes and the sensing electrodes shown in FIG. 4; FIG. 5 shows the overlapping region of the first driving pattern 11 and the first sensing pattern 21 for the convenience of explanation.

The driving electrode 10 and the second sensing electrode 20 are formed on the substrate 5, such that the overlapping region OR is present. Describing the overlapping region OR with reference to FIG. 5, insulating layers 80 are formed on the first driving patterns 11 and the first sensing patterns 21 that are disposed on the substrate 5.

The insulating layers 80 are provided with contact holes 81 exposing the first sensing patterns 21 disposed at both sides of the first driving patterns 11 and a bridge electrode 83 electrically coupling (or connecting) the first sensing patterns 21 disposed at both sides of the first driving patterns 11 to each other through the contact holes 81.

Therefore, the sensing patterns 21 and 22 are each coupled (or connected) to be continuous without being disconnected, by the bridge electrode 83 existing in the overlapping region OR.

FIGS. 4 and 5 show the case where the sensing patterns 21 and 22 spaced apart from each other and having the driving patterns 11 and 12 disposed therebetween, are each coupled (or connected) to be continuous by the bridge electrode 83. On the other hand, the driving patterns 11 and 12 spaced apart from each other and having the sensing patterns 21 and 22 disposed therebetween, may be coupled (or connected) to be continuous by the bridge electrode 83.

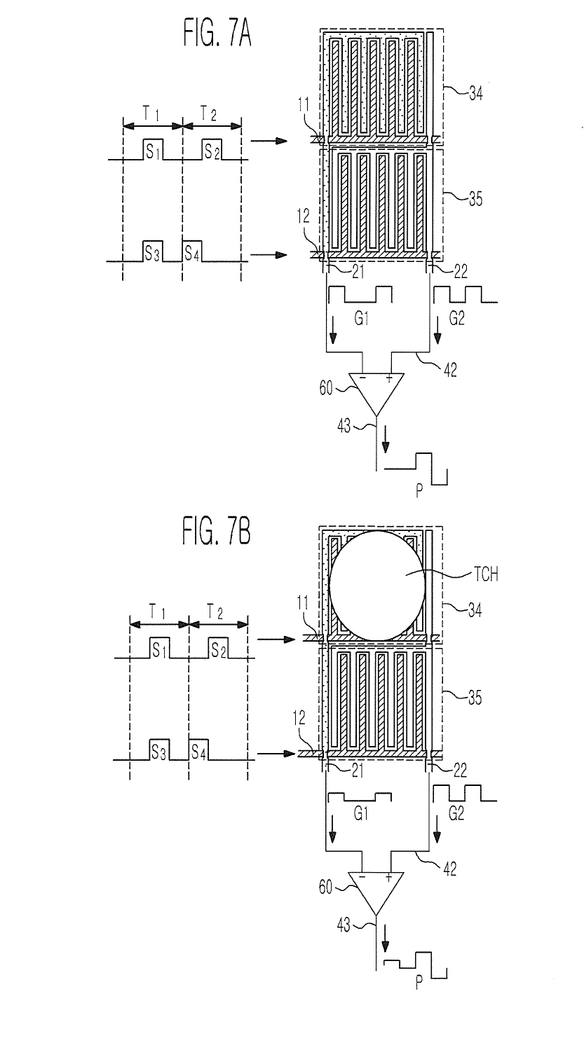

FIG. 6 is a waveform diagram showing driving signals according to an exemplary embodiment of the present invention.

Referring to FIG. 6, in one embodiment the driving signal supplying unit 50 sequentially supplies the driving signals to a plurality of driving electrodes 10_1, 10_2, and 10_3.

The driving signal includes a first driving signal S1 and a second driving signal S2 that are supplied to the first driving patterns 11, and a third driving signal S3 and a fourth driving signal S4 that are supplied to the second driving patterns 12 of each driving electrode 10.

A period in which the driving signals are supplied is divided into a first driving period T1 and a second driving period T2. In the first driving period T1, the first driving signal S1 and the third driving signal S3 are supplied and in the second driving period T2, the second driving signal S2 and the fourth driving signal S4 are supplied.

Each driving signal includes (or is formed of) a high-level voltage (for example, 1 for a digital signal).

The first driving signal S1 and the third driving signal S3, which are the same signal, may be concurrently (e.g., simultaneously) supplied while having the same voltage value.

In the second driving signal S2 and the fourth driving signal S4, as shown in FIG. 6, the fourth driving signal S4 may be first supplied and then the second driving signal S2 may be supplied, or the second driving signal S2 may be first supplied and then the fourth driving signal S4 may be supplied.

In the embodiment shown in FIG. 6, when the fourth driving signal S4 is first supplied, the falling edge of the fourth driving signal S4 falling to a low-level voltage (for example, 0 for a digital signal) from a high level voltage may overlap with the rising edge of the second driving signal S2 rising to a high-level voltage from a low-level voltage.

In addition, when the second driving signal S2 is first supplied, the falling edge of the second driving signal S2 may overlap with the rising edge of the fourth signal S4.

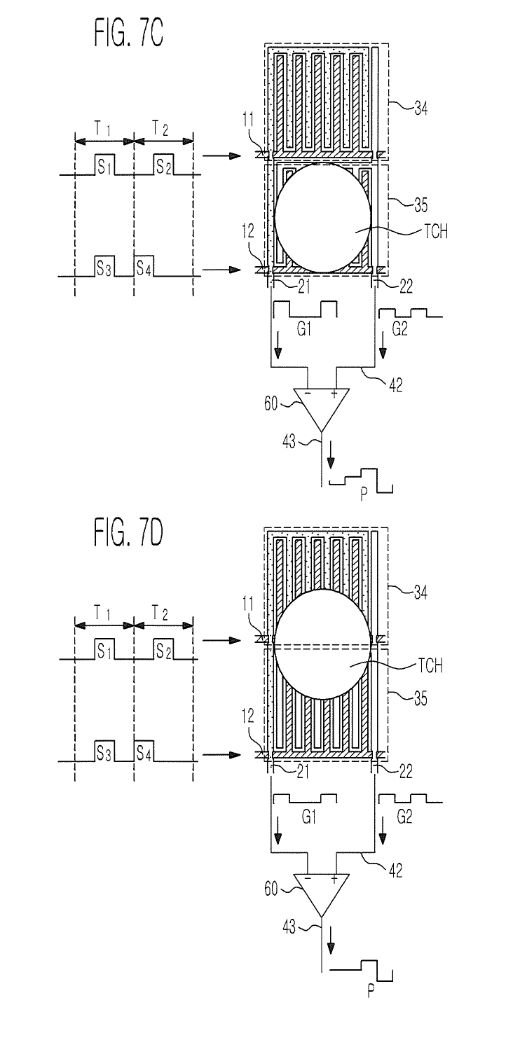

FIGS. 7A to 7D are diagrams schematically showing a driving method of a touch screen panel according to an exemplary embodiment of the present invention. For the convenience of explanation, only two sensing cells 34 and 35, which are formed of the first and second driving patterns 11 and 12 and the first and second sensing patterns 21 and 22, are shown.

In particular, FIG. 7A shows the case where the touch input TCH to the sensing cell is not present, FIG. 7B shows the case where the touch input TCH to the upper sensing cell 34 is present, FIG. 7C shows the case where the touch input TCH to the lower sensing cell 35 is present, and FIG. 7D shows the case where the touch input TCH is present at the boundary between the upper sensing cell 34 and the lower sensing cell 35.

Referring to FIG. 7A, the case where the touch input TCH to the sensing cell is not present will be described.

First, when the driving signals S1, S2, S3, and S4 are respectively supplied to the first driving pattern 11 and the second driving pattern 12 forming a single driving electrode, since the touch input TCH to each sensing cell 34 and 35 is not present, the capacitance formed between the first driving pattern 11 and the first sensing pattern 21 at the upper sensing cell 34 is output as a first detection signal G1 as it is, and is input to an inverting (−) input terminal of the differential amplifier 60. The capacitance formed between second driving pattern 12 and the second sensing pattern 22 at the lower sensing cell 35 is output as a second detection signal G2 as it is and is input to a non-inverting (+) input terminal of the differential amplifier 60.

Thereafter, the differential amplifier 60 differentially amplifies the first detection signal G1 and the second detection signal G2 applied to each input terminal, to output a differential signal P to an output terminal 43.

The touch detector 70 shown in FIG. 2 may determine that the touch input TCH is not present when the differential signal P as shown in FIG. 7A is input to the touch detector 70 from the differential amplifier 60, and may determine that the touch input TCH is present when other signals are input.

The case where the touch input TCH is present in the upper sensing cell 34 will be described with reference to FIG. 7B.

In this case, when the touch input TCH is present in the upper sensing cell 34, the capacitance formed between the first driving pattern 11 and the first sensing pattern 21 is reduced, such that the amplitude of the output first detection signal G1 is smaller than the case where the touch input TCH of FIG. 7A is not present.

However, when the touch input TCH is not present in the lower sensing cell 35, the capacitance formed between the second driving pattern 12 and the second sensing pattern 22 is maintained as it is, such that the amplitude of the output second detection signal G2 is maintained to be same as the case where the touch input TCH of FIG. 7A is not present.

The case where the touch input TCH is present in the lower sensing cell 35 will be described with reference to FIG. 7C.

In this case, when the touch input TCH is present in the lower sensing cell 35, the capacitance formed between the second driving pattern 12 and the second sensing pattern 22 is reduced, such that the amplitude of the output second detection signal G2 is smaller than the case where the touch input TCH of FIG. 7A is not present.

On the other hand, when the touch input TCH is not present in the upper sensing cell 34, the capacitance formed between the first driving pattern 11 and the first sensing pattern 21 is maintained as it is, such that the amplitude of the output first detection signal G1 is maintained to be same as the case where the touch input TCH of FIG. 7A is not present.

The case where the touch input TCH is present at the boundary between the upper sensing cell 34 and the lower sensing cell 35 will be described with reference to FIG. 7D.

In this case, when the touch input TCH is partially present in the upper sensing cell 34, the capacitance formed between the first driving pattern 11 and the first sensing pattern 21 is reduced, such that the amplitude of the output first detection signal G1 is smaller than the case where the touch input TCH of FIG. 7A is not present. However, since the touch input TCH is only partially present in the upper sensing cell 34, the amplitude of the first detection signal G1 is larger than the case of FIG. 7B.

Further, when the touch input TCH is also partially present in the lower sensing cell 35, the capacitance formed between the second driving pattern 12 and the second sensing pattern 22 is reduced, such that the amplitude of the output second detection signal G2 is smaller than the case where the touch input TCH of FIG. 7A is not present. However, since the touch input TCH is only partially present in the lower sensing cell 35, the amplitude of the second detection signal G2 is larger than the case of FIG. 7C.

The first detection signal G1 and the second detection signal G2 of an exemplary embodiment of the present invention include noises applied from the human body according to the touch input TCH. The differential amplifier 60 differentially amplifies the first detection signal G1 and the second detection signal G2 output from the most adjacent first sensing pattern 21 and second sensing pattern 22, respectively, to remove the noises generated from the human body.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel comprising:
a substrate;
a plurality of driving electrodes comprising first driving patterns and second driving patterns and arranged on the substrate along a first direction; and
a plurality of sensing electrodes comprising first sensing patterns and second sensing patterns and arranged on the substrate along a second direction crossing the first direction,
wherein first sensing cells are formed of the first driving patterns and the first sensing patterns and second sensing cells are formed of the second driving patterns and the second sensing patterns.

2. The touch screen panel according to claim 1, wherein each of the first driving patterns comprises:
a first reference pattern extending in the second direction; and
a plurality of first protruding patterns extending to one side from the first reference pattern, and
wherein each of the first sensing patterns comprises:
a third reference pattern extending in the first direction; and
a plurality of third protruding patterns extending from the third reference pattern and alternately arranged with the first protruding patterns to form the first sensing cells.

3. The touch screen panel according to claim 2, wherein each of the second driving patterns comprises:
a second reference pattern extending in the second direction; and
a plurality of second protruding patterns extending to one side from the second reference pattern, and
wherein each of the second sensing patterns comprises:
a fourth reference pattern extending in the first direction; and
a plurality of fourth protruding patterns extending from the fourth reference pattern and alternately arranged with the second protruding patterns to form the second sensing cells.

4. The touch screen panel according to claim 1, further comprising a driving signal supplying unit for sequentially supplying driving signals to the plurality of driving electrodes.

5. The touch screen panel according to claim 4, wherein the driving signal supply unit is configured to supply a first driving signal of the driving signals to the first driving patterns during a first driving period, to supply a second driving signal of the driving signals to the first driving patterns during a second driving period, to supply a third driving signal of the driving signals to the second driving patterns during the first driving period, and to supply a fourth driving signal of the driving signals to the second driving patterns during the second driving period.

6. The touch screen panel according to claim 5, wherein the third driving signal is concurrently supplied with the first driving signal.

7. The touch screen panel according to claim 1, further comprising a plurality of differential amplifiers having input terminals, each of the differential amplifiers being coupled to the first sensing pattern and the second sensing pattern in a corresponding one of the sensing electrodes.

8. The touch screen panel according to claim 7, further comprising a touch detector coupled to an output terminal of each of the differential amplifiers.

9. A method of driving a touch screen panel comprising:
(a) sequentially supplying a first driving signal and a third driving signal to each driving electrode of a plurality of driving electrodes during a first driving period, wherein the first driving signal and the third driving signal are concurrently supplied to a first driving pattern and a second driving pattern of each of the driving electrodes;
(b) sequentially supplying a second driving signal and a fourth driving signal to each driving electrode of the plurality of driving electrodes during a second driving period, wherein the second driving signal is supplied to the first driving pattern of each of the driving electrodes and the fourth driving signal is supplied to the second driving pattern of each of the driving electrodes;
(c) differentially amplifying a first detection signal and a second detection signal output from a first sensing pattern and a second sensing pattern of each sensing electrode of a plurality of sensing electrodes, respectively, to remove noises while generating differentially amplified detection signals; and
(d) recognizing touch coordinates by using the differentially amplified detection signals.

10. The method according to claim 9, wherein the first driving pattern and the first sensing pattern form a first sensing cell and the second driving pattern and the second sensing pattern form a second sensing cell.

11. The method according to claim 10, wherein the first driving pattern comprises:
a first reference pattern extending in a second direction; and
a plurality of first protruding patterns extending to one side from the first reference pattern, and
wherein the first sensing pattern comprises:
a third reference pattern extending in a first direction; and
a plurality of third protruding patterns extending from the third reference pattern and alternately arranged with the first protruding patterns to form the first sensing cell.

12. The method according to claim 11, wherein the second driving pattern comprises:
a second reference pattern extending in the second direction; and
a plurality of second protruding patterns extending to one side from the second reference pattern, and
wherein the second sensing pattern comprises:
a fourth reference pattern extending in the first direction; and
a plurality of fourth protruding patterns extending from the fourth reference pattern and alternately arranged with the second protruding patterns to form the second sensing cell.
